(19) United States
(12) Patent Application Publication
(10) Pub. No.: US 2010/0034102 A1
(43) Pub. Date: Feb. 11, 2010

(54) Measurement-Based Validation of a Simple Model for Panoramic Profiling of Subnet-Level Network Data Traffic

(75) Inventors: Jia Wang, Randolph, NJ (US); Zihui Ge, Florham Park, NJ (US); Hongbo Jiang, Cleveland, OH (US); Shudong Jin, Solon, OH (US)

Correspondence Address: AT&T Legal Department - HB;Patent Docketing, One AT&T Way, Room 2A-207, Bedminster, NJ, 07921, US

(73) Assignee: AT&T INTELLECTUAL PROPERTY I, LP, Reno, NV (US)

(21) Appl. No.: 12/186,113

(22) Filed: Aug. 5, 2008

(51) Int. Cl. H04L 12/26

(52) U.S. Cl. 370/252

(57) ABSTRACT

A system and method for profiling subnet-level aggregate network data traffic is disclosed. The system allows a user to define a collection of features that combined characterize the subnet-level aggregate traffic behavior. Preferably, the features include daily traffic volume, time-of-day behavior, spatial traffic distribution, traffic balance in flow direction, and traffic distribution in type of application. The system then applies machine learning techniques to classify the subnets into a number of clusters on each of the features, by assigning a membership probability vector to each network thus allowing panoramic traffic profiles to be created for each network on all features combined. These membership probability vectors may optionally be used to detect network anomalies, or to predict future network traffic.

### BACKGROUND OF THE INVENTION

1. Field of the Invention

The present invention generally relates to network profiling, and more particularly to profiling of subnet-level network data traffic.

2. Brief Description of the Related Art

One of the key contributors to the phenomenal success of the Internet nowadays is the large variety of applications and services available. The traffic over the Internet, consisting of a mixture of data packets, is therefore highly diverse, ranging from user driven activities such as web browsing, music sharing, and e-banking, to machine driven activities such as remote system backup, network measurement, and web crawling, and even to malicious DDoS attacks, worms, and virus activities. Understanding the behavior of the network traffic is hence cardinal for properly and efficiently managing network resources. For example, quantifying traffic volume, as in a representation of a traffic demand matrix, provides an important input for traffic engineering tasks such as routing optimization. Application identification of traffic flows is an important component for application-dependent QoS controls. Characterizing the traffic over a backbone link has been successful in distinguishing unwanted traffic and anomalies so as to provide crucial information for a mitigation strategy.

As a means to obtain knowledge of traffic behavior, traffic measurement and profiling has recently become an active research area. An increasing amount of capital being put in building traffic monitoring and measurement infrastructures, and large-scale and fine-grained traffic measurement data becomes available. For a typical Internet service provider (ISP) network, link monitoring data from SNMP and flow monitoring data are collected on a regular basis. Even though the operational and processing costs of the collection of measurement are non-trivial (due to its tremendous data volume), the use of measurement data has been limited to, for example, generating various traffic statistics from network-wide data, leaving other data unexplored and yet fully exploited. The reasons, among others, include the sheer volume of measurement data, and the lack of models to capture, and techniques to extract, its complex manifold traffic behavior.

There exists a rich body of prior work on traffic classification and behavior profiling, many of which has explored and positively advocated the use of machine learning techniques. At the IP flow level, some studies consider the problem of determining the application (or the nature of the application) of IP flows. One implementation uses supervised machine learning techniques, including the nearest neighbor approach and linear discriminant analysis, to partition IP flows into four classes: interactive, bulk-transfer, streaming, and transaction. Another implementation suggests using Naive Bayes as a classifier and demonstrates a high accuracy in classifying traffic. Other implementations, on the other hand, use unsupervised machine learning techniques to cluster traffic flows. An expectation-maximization (EM) algorithm has been applied for building the classification model. In all of the above, flow statistics such as the inter-arrival time and the mean and variance of packet size have been extracted, in addition to packet header information, as features for classification. Focusing on resource consumption in network traffic, other implementations use a clustering method that groups traffic with significant patterns along one or multiple dimensions using fixed volume thresholds.

At the host level, machine learning techniques have also been applied for behavioral modeling. One implementation uses both clustering based approaches (e.g., anomaly detection on nearest neighbor distance and density based local outlier factor) and unsupervised support vector machine algorithms for detecting intrusions. Another implementation uses agglomerative hierarchical clustering to profile host behavior and detect anomalies by tracking membership changes. The feature set in the above includes the total counts of bytes, packets and connections observed in a time window, as well as the distribution of those among different peer hosts.

At the link level, one implementation uses agglomerative hierarchical clustering to classify traffic over a given link by its connection characteristics. This classification distinguishes traffic classes such as P2P file sharing, mail, Web, etc. Another implementation creates rules for traffic classification by looking at a variety of features at the social, functional, and application levels. Yet another implementation creates behavioral clusters from the source and destination IP addresses and port distributions and uses entropy to quantify traffic feature distributions.

On the contrary, there is little research work on characterizing traffic at the subnetwork (or “subnet”) level of aggregation, despite the fact that subnets, or portions of a network that share a common network address prefix, are the smallest routable entities in the Internet.

### SUMMARY OF THE INVENTION

A system and method for profiling subnet-level aggregate traffic is disclosed. The system allows a user to define a collection of features that, when combined, characterize the subnet-level aggregate traffic behavior. Preferably, the network traffic features include daily traffic volume, time-of-day behavior, spatial traffic distribution, traffic balance in flow direction, and traffic distribution in type of application. The system then applies machine learning techniques to classify the subnets into a number of clusters, on each of the features, by assigning a cluster membership probability vector to each subnet thus allowing panoramic traffic profiles to be created for each network on all features combined.

Various aspects of the invention relate to classifying subnet-level traffic into clusters and deriving a network profile from the clusters. For example, according to one aspect, a method of profiling network traffic includes probabilistically classifying subnet-level aggregate data traffic into a plurality of clusters based on a plurality of network features, and deriving a network profile for at least one of a first and second network from the plurality of clusters in response to receiving traffic measurement data. The method can also include defining a plurality of network traffic features that combined characterizes the subnet-level aggregate data traffic.

In one preferred embodiment, the method includes combining the plurality of network traffic features to characterize the subnet-level aggregate data traffic. Preferably, the method includes selecting the network traffic features from the group consisting essentially of daily aggregate traffic volume, traffic distribution in time, traffic distribution in space, traffic distribution in application, flow size distribution, traffic balance in flow direction.

In one preferred embodiment, the step of classifying probabilistically includes using a Bayes classifier. In another preferred embodiment, the step of classifying probabilistically includes using a K-means clustering algorithm to determine at least one of the plurality of clusters. The method can also include calculating a cluster membership probability vector for each of the clusters. Preferably, the method also includes selecting the number of clusters using at least one of a Bayesian information criterion (BIC) and Akaike information criterion (AIC) algorithm.

The probabilistic classification generated by the classifier may be further processed to create a specific type of network profile. In one embodiment, for example, the data is used to identify network anomalies, or unexplained changes in network traffic. In other embodiments, the data may be used to generate a network traffic demand matrix, or a breakdown of the network traffic expected under certain specified conditions.

In another aspect of the invention, a system for profiling network traffic includes a first and second network, a classifier module coupled operatively to the first and second network, the classifier module adapted to classify probabilistically subnet-level aggregate data traffic into a plurality of clusters based on a plurality of network features, and a profile module coupled operative to the first and second network. Preferably, the profile module is adapted to derive a network profile for at least one of the first and second network from the plurality of clusters in response to receiving traffic measurement data.

In one preferred embodiment, the classifier module identifies a plurality of network features that combined characterizes the subnet-level aggregate data traffic. Preferably, the classifier module combines the plurality of network features to characterize the subnet-level aggregate data traffic.

Preferably, the classifier module selects the network features from the group consisting essentially of daily aggregate traffic volume, traffic distribution in time, traffic distribution in space, traffic distribution in application, flow size distribution, traffic balance in flow direction. In one preferred embodiment, the classifier module uses a Bayes classifier to classify probabilistically. In another preferred embodiment, the classifier module uses a K-means clustering algorithm to determine at least one of the plurality of clusters. Preferably, the classifier module also calculates a cluster membership probability vector for each of the clusters. In one preferred embodiment, the profile module selects the number of clusters using at least one of a Bayesian information criterion (BIC) and Akaike information criterion (AIC) algorithm.

In yet another aspect, a computer readable medium including instructions executable by a computing device that, when applied to the computing device, cause the device to probabilistically classify subnet-level aggregate data traffic into a plurality of clusters based on a plurality of network traffic features, and derive a network profile for at least one of a first and second network from the plurality of clusters in response to receiving traffic measurement data.

Preferably, the computer readable medium also includes instructions that, when applied to the machine, cause the machine to select the network features from the group consisting essentially of daily aggregate traffic volume, traffic distribution in time, traffic distribution in space, traffic distribution in application, flow size distribution, traffic balance in flow direction.

Several benefits can be derived from the present invention. For example, derived traffic profiles can be of interest to a broad range of applications such as network design, network management, traffic engineering, and network security and surveillance. The system can also be used to detect small clusters of subnets with low traffic volume, distinct but less stable diurnal patterns, as well as benefit the development of applications for more efficient network management.

Other objects and features of the present invention will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

FIG. 1 is a block diagram of a typical Tier-1 Internet Service Provider network.

FIG. 2 is an example of a Gaussian mixture model fitting an empirical distribution.

Like reference symbols in the various drawings indicate like elements.

### DETAILED DESCRIPTION OF THE PREFERRED EMBODIMENTS

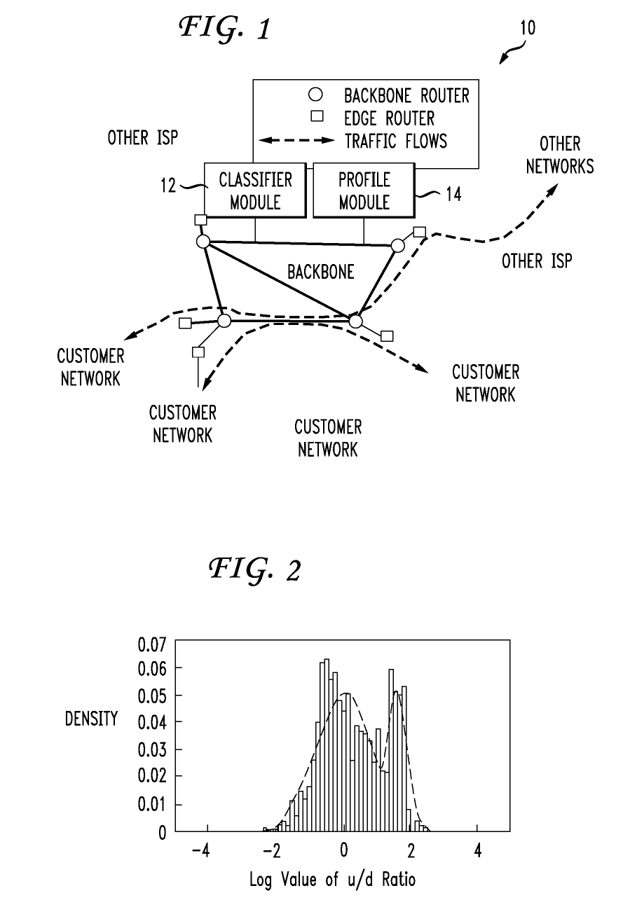

Referring to FIG. 1, a system 10 that can discover the structural patterns in traffic carried by a single network in the Internet, in particular a large Internet Service Provider (ISP) network, is shown. First an ISP-centric view at the structure of the Internet and its traffic flows will be described.

The Internet comprises hundreds of thousands of autonomous but interconnected networks, forming a loosely hierarchical structure. Each such network, i.e., an autonomous system (AS), owns a collection of routers and hosts that share one or more blocks of IP addresses (subnets), and exchanges IP traffic to other networks either by directly connecting to the destination network (e.g., peering) or by obtaining service from an Internet service provider (ISP). An ISP network can be responsible for delivering the traffic received from its customer networks to the destination network, or forwarding the traffic to other ISPs that have a route to the destination. As shown in FIG. 1, the traffic from customer networks, which can range from enterprise networks of different scales to regional ISPs, is preferably intercepted via a set of access links and is routed via a high speed backbone towards the destination networks. In order to properly and efficiently manage the network resources, it is therefore of great interest for ISP networks to monitor and characterize the behavior of the traffic among different autonomous networks, especially the traffic that traverses the ISP network. Such monitoring is referred to as “profiling,” and the resulting data is a “network profile.”

Consistent with the granularity of traffic management activities such as routing and accounting, which can be defined on a per-network-basis or on a per-subnet basis, traffic data can be analyzed at a network-level of aggregation

Changes in the aggregate traffic behavior can occur, mostly due to two reasons: (a) changes in the traffic demand, which may be the result of a newly introduced service or application in the network, or due to an anomalous traffic event such as flash crowd or DOS attack; (b) inter-domain or intra-domain routing changes, which can occur when a network topology changes or when a multi-homed customer network modifies its routing preference. In either case, it is important for ISPs to discover and respond to those new traffic patterns so as to optimally utilize the available network resources and provide satisfactory service to customer networks.

One of the most widely used traffic monitoring tools in the Internet nowadays is the Cisco Netflow, which is supported by many other vendors as well. Netflow is a software utility included in router IOS that generates traffic measurement data—specifically, flow statistics of the traffic flowing through the router. As used herein, the term ‘flow’ is defined as a unidirectional sequence of packets between a particular source and destination IP address pair. For each flow, Netflow maintains a record in router memory containing a number of fields including the source and destination IP addresses, source and destination BGP routing prefixes, source and destination port numbers, transport protocol, type of service, flow starting and finishing timestamps, and number of bytes and number of packets transmitted. Flow records that contain per flow statistic information are transmitted to a Netflow collector, which is a server machine that stores the flow records and conducts further data aggregation and processing. As maintaining Netflow data can be computationally expensive for routers, packet sampling, either deterministic or random, is commonly enabled. Similarly, in order to reduce the transmission and storage overhead at the Netflow collector, flow-level sampling techniques can also be applied. With both packet-level and flow-level sampling in place, one can still derive accurate estimation of the overall traffic properties provided a sufficient aggregation level of the flow records.

Netflow measurement provides the traffic information of a single router. In order to obtain the traffic information of an entire network, Netflow measurement needs to be enabled and collected at multiple routers in the network. While the location for the most cost-effective deployment of Netflow can be determined by solving an optimization problem, a widely applied strategy in practice is to have Netflow covering the edge of the entire backbone network, for example, to enable Netflow monitoring for all ingress links to the backbone. The flow records from the distributed Netflow collectors are then sent to a centralized database, where a network wide view of the traffic status can be derived.

For a large network, the cost of transmission and storage of Netflow measurement data is non-trivial, largely due to the tremendous volume of the flow records. Nowadays, a tier-1 ISP typically carries thousands of terabyte of traffic a day, which would generate hundreds of billions of Netflow records. Even with moderately aggressive packet-level and flow-level sampling, the amount of Netflow data can easily reach tens of gigabyte per day. Bearing with such a cost, one would naturally hope to fully exploit this data set. The present system provides a method to construct network-level traffic profiles from this data set and apply the derived traffic profiles for applications such as traffic prediction and anomaly detection.

As shown in FIG. 1, in one preferred embodiment, the system includes a classifier module 12 and a profile module 14. The profile module 14 derives a network profile from one or more clusters of subnets identified by the classifier 12. In one preferred embodiment, the profile module 14 derives the network profile in response to receiving subnet-level traffic measurement data from the routers in each cluster.

In order to construct a behavioral profile for the Internet traffic originating from or destined to a specific network, the classifier 12 identifies attributes of interest that are pertinent for traffic management and traffic engineering. In one preferred embodiment, the classifier 12 identifies the following features for characterizing aggregate traffic behavior. Many of these features can come from direct input from network operation teams such as those for network design and capacity planning. For each source or destination subnet and each direction of the traffic flow, the classifier 12 collects the following attributes of interest:

Daily aggregate traffic volume (V). This feature measures the total traffic volume to and from a specific network. It can be measured either in total number of bytes observed, or as an average traffic rate in bits per second. Different metrics of the aggregate traffic volume can be useful in different applications. For example, the 95th percentile traffic rate as opposed to the average is conventionally considered for billing purposes.

Traffic distribution in time (T). This feature measures the traffic volume distribution over the time of day. The classifier 12 represents it as a vector where the number of dimensions is determined by the aggregation granularity (e.g., 24 for hourly aggregated traffic). Properly multiplexing traffic that has distinct time-of-day behaviors (e.g., business versus residential traffic) can help improve the efficiency in utilizing the network resource.

Traffic distribution in space (P). This feature characterizes the traffic volume distribution over different source or destination networks. By combining this information for all networks, the classifier can derive a traffic matrix at the subnet-to-subnet level. With respect to an ISP network, the spatial distribution is of-ten aggregated to the different ingress or egress points of the network, which can greatly reduces the dimension of the data. However, such an aggregation can make the traffic matrix sensitive to intra-domain routing changes, which may or may not be desirable depending on the application requirements.

Traffic distribution in application (A). This feature characterizes the application mix of the network traffic. For example, this feature can be used for predicting the application impact by a routing change or a congestion event. In one preferred embodiment, the port information collected in Netflow records can be readily available for port-based classifications.

Flow size distribution (F). The distribution of the size of IP flows can provide information on the nature of the traffic content. For instance, signaling and control messages such as a HTTP request are typically small in size, while textual content, image content, and multimedia content exhibit larger flow sizes in ascending order. Abrupt changes in the flow size distribution of-ten imply on-going anomalous traffic events such as worm activities or DDoS attacks.

Traffic balance in flow direction (U). This feature measures the upload-download ratio of a given net-work. For example, a network consisting of mostly “server-like” hosts can have a heavier up-loading (i.e., egress) traffic than downloading (i.e., ingress) traffic; meanwhile, a network of clients, such as a DSL farm, could have a reversed relationship in its traffic upload-download ratio. This feature characterizes the “server-client-mixes” of the network hosts.

Given the features described above, the traffic in a specific subnet i can hence be represented by the classifier 12 as a 7-tuple

[symbol]

i, V, T, P, A, F, U [symbol] ε [symbol] × [symbol] × [symbol] × [symbol] × [symbol] × [symbol] ×

[symbol]

where i is the index of the subnet and d_{X} is the dimension of feature X. The classifier 12 preferably groups subnets into clusters according to their similarity with respect to this feature vector.

It should be appreciated by one skilled in the art that the above identified feature list is not exhaustive, but is instead described to demonstrate the applicability of machine learning techniques applied by the system.

With the set of features determined, the classifier module 12 next classifies the aggregate traffic and the profile module 14 can profile data traffic behavior with respect to those features. For example, consider an arbitrary feature whose dimension is d. With respect to this feature, the classifier 12 can classify the traffic data into a number of clusters which exhibit distinct characteristics and behaviors. In one preferred embodiment, the classifier uses a statistical classification technique known as a Bayes classifier in statistical decision theory. Specially, Gaussian mixture models are among the most statistically mature methods, and are often used to describe the clusters. Under such a model, a d-dimensional data point χ belongs to any of the K clusters whose probability distribution functions are summed up to

$${\sum }_{k = 1}^{K} {α}_{k} G ( x ; {μ}_{k} , {σ}_{k} ) ,$$

where each G(χ; μₖ; σₖ), 1≦k≦K, is the Gaussian distribution function with d-dimensional mean (also called the centroid of the cluster) and variance σₖ², and αₖ denotes the mixture proportion, or the frequency that χ belongs to cluster k. With the parameters supplied, the classifier 12 then calculates the probability that the data χ belongs to cluster k, hereinafter referred to as the membership probability:

$$p ( k \vert x ) = \frac{{α}_{k} G ( x ; {μ}_{k} , {σ}_{k} )}{{\sum }_{j = 1}^{K} {α}_{j} G ( x ; {μ}_{j} , {σ}_{j} )} .$$

The vector of probabilities obtained, or the cluster membership probability vector p=(p₁,p₂, . . . ,pₖ), approximately characterizes the original data point χ by indicating the probability that χ belongs to each of the K clusters.

Although the use of such probabilistic classification has been shown effective and robust against measurement errors, there exist additional reasons to favor this representation (using membership probabilities) over the original data. First, it is more understandable to network operators, who often like to describe network traffic using typical values, i.e. the cluster centroids. Second, it provides a more convenient way to monitor the changes in traffic behavior. For example, an oscillation or drift in the probability vector may indicate decreased accuracy of the model and an increased need to adjust the model.

FIG. 2 illustrates the Gaussian mixture model using, as an example, an empirical distribution obtained from a sample network-level traffic data set. It shows the histogram of one of the selected features, “Traffic balance in flow direction”. The histogram is characterized by two peaks, one at 1.5<χ<2 and the other at χ<0. As the x-axis is the common logarithm (with base 10) of upload-download traffic ratio, the first peak tells that a sizable portion of the traffic comes from networks with mainly servers, which may have a remarkable upload-download ratio between 30:1 and 100:1. Conversely, the other wider peak indicates that a larger portion of the traffic is exchanged among networks that absorb more traffic than they produce. These two distinguishable sets of networks are approximately captured by the two Gaussian distributions, which add up to the model distribution shown by the dashed line.

Given a traffic data set χᵢ, 1≦i≦N, and a cluster description model with K clusters on a feature, the classifier 12 quantitatively identifies the clusters. That means that the system provides values for the parameters αₖ, μₖ, and σₖ for all 1≦k≦K. In one preferred embodiment, the classifier 12 uses a-means clustering algorithm. The K-means method uses the squared Euclidean distance to define the objective function, and attempts to classify data points into clusters that minimize the sum of all intra-cluster variances:

$$min S = {\sum }_{k = 1}^{K} {\sum }_{i = 1}^{N} {Z}_{ki} {‖ {x}_{i} - {μ}_{k} ‖}^{2} ,$$

where μₖ is the geometric centroid of the data items in cluster k, and Zki=1 if and only if the data χᵢ is classified into cluster k. To solve this K-means optimization problem, the classifier 12 assigns data items at random to the K clusters, and then iterations containing two steps are applied to obtain an approximation for μₖ. By re-assigning Zₖᵢ and re-estimating μₖ until the assignment and estimation become stable, the classifier 12 calculates a centroid μₖ of each cluster k. Finally, the remaining parameters are derived accordingly: σₖ² is approximated by the mean square error of the data items in the cluster, and αₖ is given by the size of the cluster as portion of the size of the entire data set.

While classifying the data, the classifier 12 also determines the number of clusters, K. In one preferred embodiment, the classifier 12 uses the Bayesian information criterion (BIC), for model selection. BIC selects a value for K that minimizes the BIC formula, 2 ln L+K ln N, where N is the number of data points in the data set, and L is the maximum value of the likelihood function when the model is applied to K. This formula is a decreasing function of L. In another preferred embodiment, the classifier 12 uses the Akaike information criterion (AIC). AIC selects a value for K that minimizes the AIC formula, −2 ln L+2K, which penalizes free parameter K less strongly than BIC. As a result, the AIC measure allows the classifier 12 to identify a larger number of clusters, which could be useful in some applications.

Preferably, the data set is classified into different numbers of clusters on different features. For example, when the dimension of a feature is high, the system obtains fine-grained classification of the networks.

In some embodiments, the profiler 14 uses data from the classifier 12 to derive a network profile that includes information associated with network traffic anomalies, or sudden changes in traffic volume. Given a target observation from time i and a set of network traffic features, the classifier 12 calculates the target cluster membership probability vector pᵢ. The profiler 14 then calculates a predicted cluster membership probability vector \hat{p}ᵢ, based on past observations. In one embodiment, the profiler 14 estimates \hat{p}ᵢ as the mean of the M observations immediately preceding time i:

$${\hat{p}}_{i} = \frac{1}{M} {\sum }_{j = i - M}^{i - 1} {p}_{j} .$$

The profiler 14 indicates an anomaly when ∥pᵢ−\hat{p}ᵢ∥ exceeds some threshold.

In one embodiment, the profiler 14 indicates an anomaly when ∥pᵢ−\hat{p}ᵢ∥>σδ₆₀, where σ is the standard deviation of the prediction and δ_{α} is selected to achieve an acceptable error rate. σ may be determined using the estimated variance

$${\hat{σ}}^{2} = \frac{1}{M} {\sum }_{j = i - M}^{i - 1} {‖ {p}_{j} - E ( p ) ‖}^{2} ,$$

where E(p) is the mean value.

In another embodiment, the profiler 14 uses data from the classifier 12 to derive a network profile that includes an estimated traffic demand matrix. A traffic demand matrix reports the expected volume of network traffic exhibiting certain combinations of selected network traffic features. ISPs might use such information to predict the behavior of their network after a new customer network joins.

To derive an estimated traffic demand matrix for the set of network traffic features f₁, f₂, . . . , fₘ, the classifier 12 first computes the cluster membership probability vector pᵢ^{(f}^{ₙ}⁾ for each subnet i and each feature fₙ. The classifier 12 also computes the centroid vector

Â^{(f}^{ₙ}^{)=(μ}₁^{(f}^{ₙ}⁾, μ₂^{(f}^{ₙ}⁾, . . . , μ_{K}_{^{(f}}ₙ_{⁾}^{(f}^{ₙ}⁾)

for each feature fₙ, where K^{(f}^{ₙ}⁾ is the number of clusters on feature fₙ, and μⱼ^{(f}^{ₙ}⁾ is the centroid of the jth cluster. Finally, the profiler 14 generates the estimated traffic demand matrix

$$\hat{D} = N \overline{υ} ( \frac{1}{N} {\sum }_{i} ( {\hat{A}}^{( {f}_{1} )} {p}_{i}^{( {f}_{1} )} ) \times \frac{1}{N} {\sum }_{i} ( {\hat{A}}^{( {f}_{2} )} {p}_{i}^{( {f}_{2} )} ) \times … \times \frac{1}{N} {\sum }_{i} ( {\hat{A}}^{( {f}_{in} )} {p}_{i}^{( {f}_{in} )} ) ) ,$$

where N is the number of subnets, and ν̅ is the mean traffic volume per subnet. (The N ν̅ factor is omitted if daily traffic volume is one of the selected features fₙ.)

A number of embodiments of the invention have been described. Nevertheless, it will be understood that various modifications may be made without departing from the spirit and scope of the invention. For example, the classifier and profile modules can execute on one or more servers and can be modified to perform one or more of various functions described above. Also, the steps described above may be modified in various ways or performed in a different order than described above, where appropriate. Accordingly, alternative embodiments are within the scope of the following claims.

What is claimed is:

1. A method of profiling network traffic comprising:
determining a probabilistic classification of a plurality of subnets into a plurality of clusters based on at least one network traffic feature; and
deriving a network profile using said probabilistic classification and traffic measurement data associated with at least one of said plurality of subnets.

2. The method of claim 1, wherein said at least one network traffic feature includes at least one of daily aggregate traffic volume, traffic distribution in time, traffic distribution in space, traffic distribution in application, flow size distribution, and traffic balance in flow direction.

3. The method of claim 1, wherein determining a probabilistic classification comprises using at least one of a Bayes classifier or a K-means clustering algorithm.

4. The method of claim 1, wherein the number of clusters is selected probabilistically.

5. The method of claim 4, wherein probabilistically selecting the number of cluster comprises using at least one of an Akaike information criterion (AIC) algorithm or a Bayesian information criterion (BIC) algorithm.

6. The method of claim 1, wherein said network profile comprises information associated with anomalous network traffic.

7. The method of claim 1, wherein deriving a network profile comprises:
determining a target cluster membership probability vector for at least one subnet of said plurality of subnets based on at least one target network traffic feature;
calculating a predicted cluster membership probability vector for said subnet based on a set of cluster membership probability vectors, said set of cluster membership probability vectors comprising at least one cluster membership probability vector determined for said subnet based on said at least one target network traffic feature; and
comparing the difference between said target cluster membership probability vector and said predicted cluster membership probability vector to a threshold.

8. The method of claim 7, wherein said threshold is a function of the variance of said set of cluster membership probability vectors.

9. The method of claim 1, wherein said network profile comprises at least one network traffic feature value and a prediction of network traffic exhibiting said at least one network traffic feature value.

10. A system for profiling network traffic comprising a computing device, the computing device being configured to probabilistically classify a plurality of subnets into a plurality of clusters based on at least one network traffic feature, the computing device being configured to derive a network profile in response to receiving traffic measurement data associated with at least one of said subnets.

11. The system of claim 10, wherein said at least one network traffic feature includes at least one of daily aggregate traffic volume, traffic distribution in time, traffic distribution in space, traffic distribution in application, flow size distribution, and traffic balance in flow direction.

12. The system of claim 10, wherein the computing device uses at least one of a Bayes classifier or a K-means clustering algorithm to probabilistically classify.

13. The system of claim 10, wherein the computing device selects the number of clusters probabilistically.

14. The system of claim 13, wherein the computing device uses at least one of an Akaike information criterion (AIC) algorithm or a Bayesian information criterion (BIC) algorithm to select the number of clusters.

15. The system of claim 10, wherein said network profile comprises information associated with anomalous network traffic.

16. The system of claim 15, wherein said computing device determines a target cluster membership probability vector for at least one subnet of said plurality of subnets based on at least one target network traffic feature, said computing device calculating a predicted cluster membership probability vector for said subnet based on a set of cluster membership probability vectors, said set of cluster membership probability vectors including at least one cluster membership probability vector determined for said subnet based on said at least one target network traffic feature, said computing device comparing the difference between said target cluster membership probability vector and said predicted cluster membership probability vector to a threshold.

17. The system of claim 16, wherein said threshold is a function of the variance of said set of cluster membership probability vectors.

18. The system of claim 10, wherein said network profile comprises at least one network traffic feature value and a prediction of network traffic exhibiting said at least one network traffic feature value.

19. A computer readable medium comprising instructions executable by a computing device that, when applied to the computing device, cause the device to:
determine a probabilistic classification of a plurality of subnets into a plurality of clusters based on at least one network traffic feature; and
derive a network profile in using said probabilistic classification and traffic measurement data associated with at least one of said plurality of subnets.

20. The computer readable medium of claim 19, wherein said at least one network traffic feature includes at least one of daily aggregate traffic volume, traffic distribution in time, traffic distribution in space, traffic distribution in application, flow size distribution, and traffic balance in flow direction.
